(19) United States
(12) Patent Application Publication
(10) Pub. No.: US 2007/0288279 A1
(43) Pub. Date: Dec. 13, 2007

(54) Entering And Using Time Ranges

(75) Inventors: Todd Haugen, Clyde Hill, WA (US); Doreen N. Grieb, Kirkland, WA (US); John E. Knapp, Seattle, WA (US); Melinda E. Nascimbeni, Seattle, WA (US); Suzan M. Andrew, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/422,837

(22) Filed: Jun. 7, 2006

(51) Int. Cl. G06F 9/46

(52) U.S. Cl. 705/8

(57) ABSTRACT

Systems and methods for entering, associating, and using ranges of time. A time range may be generated using input including concepts that have meaning to a user and the time range's relation to characteristics of other entities, and may be associated with a variety of items, like tasks, appointments, and reminders. A time range may be used for various purposes including, for example, to display items, to remind users of items, and as input to other processes.

### BACKGROUND

People use a variety of mechanisms, including various applications and services, to record and track responsibilities and things that need to be accomplished. For example, it is common for personal information management software to include functionality that enables users to create and manage items like tasks and appointments, including associating dates and times—including due dates—with such items. In some instances, such software may use a date or time associated with an item to remind a user that some action associated with that item needs to be accomplished. In other instances, the date or time may be used for other purposes.

### SUMMARY

The following presents a simplified summary of the disclosure in order to provide a basic understanding to the reader. This summary is not an extensive overview of the disclosure and does not identify key or critical elements of the invention or delineate the scope of the invention. Its sole purpose is to present some concepts disclosed herein in a simplified form as a prelude to the more detailed description that is presented later.

Described herein are various technologies and techniques directed to entering and using time ranges in the management of items, including, for example, items like tasks and appointments.

When creating an item like a task, it may be more intuitive or ultimately useful for a user to associate a range of time with the item, rather than to associate a single time or date. A user may enter such a range of time with input like concepts that have meaning to the user and the time range's relation to characteristics of other entities, like events or appointments.

Furthermore, using a range of time associated with an item, it may be possible to provide functionality to a user that may either be more difficult or not possible to provide when there is only a single time or date associated with the item. This improved functionality may include displaying items, reminding users of items, and using time ranges as input to other processes.

### DESCRIPTION OF THE DRAWINGS

FIG. 1 illustrates an exemplary generalized operational flow including various operations that may be performed when entering, associating, and using time ranges with tasks.

FIG. 2 illustrates an exemplary block diagram that demonstrates some of the inputs that might be used when creating or specifying a time range.

FIG. 3 illustrates one example of a user interface that may be displayed when using tasks that have associated time ranges.

FIG. 4 illustrates another example of a user interface that may be displayed when using tasks that have associated time ranges.

FIG. 5 illustrates a diagram demonstrating the operation of an exemplary reminder module that determines and raises reminders using time ranges associated with items.

FIG. 6 illustrates an example of an application user interface reminder shown in the user interface of an application.

FIG. 7 illustrates an example of an application user interface reminder implemented as a dialog box.

FIG. 8 illustrates an example of one type of non-dialog box application user interface reminder displayed outside of the interface of an application.

FIG. 9 illustrates an exemplary generalized operational flow including various operations that may be performed using a time range without associating the time range with an item.

FIG. 10 illustrates an exemplary system in which the entry, association, and use of time ranges may occur.

FIG. 11 illustrates an exemplary computer device in which the various technologies described herein may be implemented.

### DETAILED DESCRIPTION

The present invention extends to various technologies and techniques directed to entering and using time ranges. More particularly, described herein are, among other things, methods, systems, user interfaces, and data structures that facilitate the entering, association of, and use of time ranges in the management of items, including tasks and appointments.

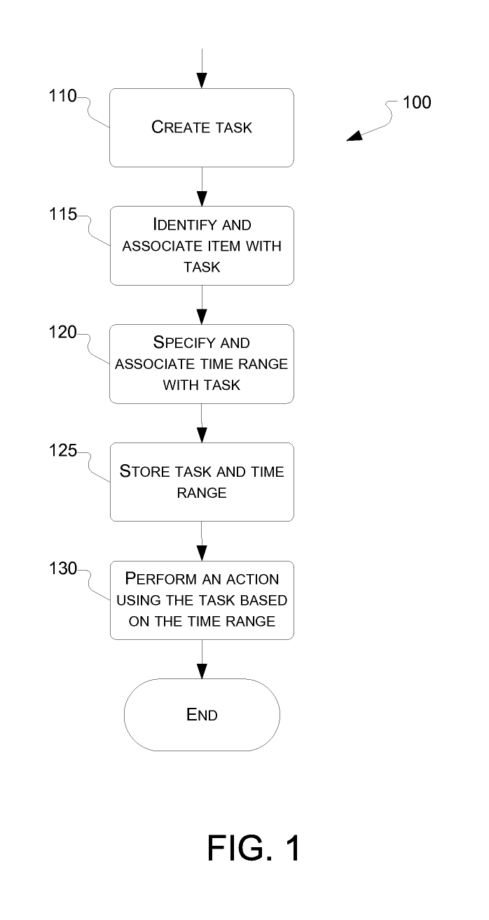

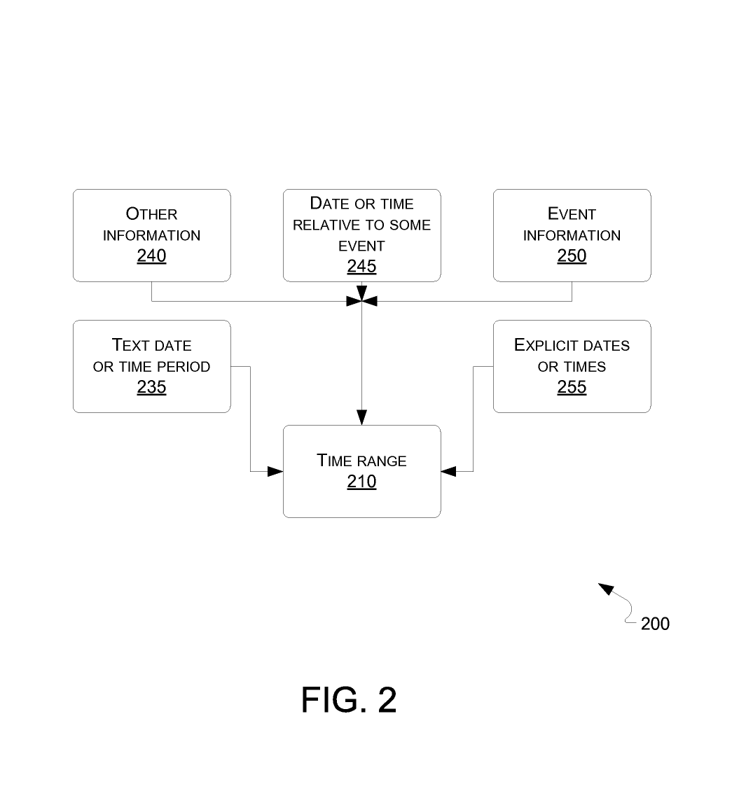

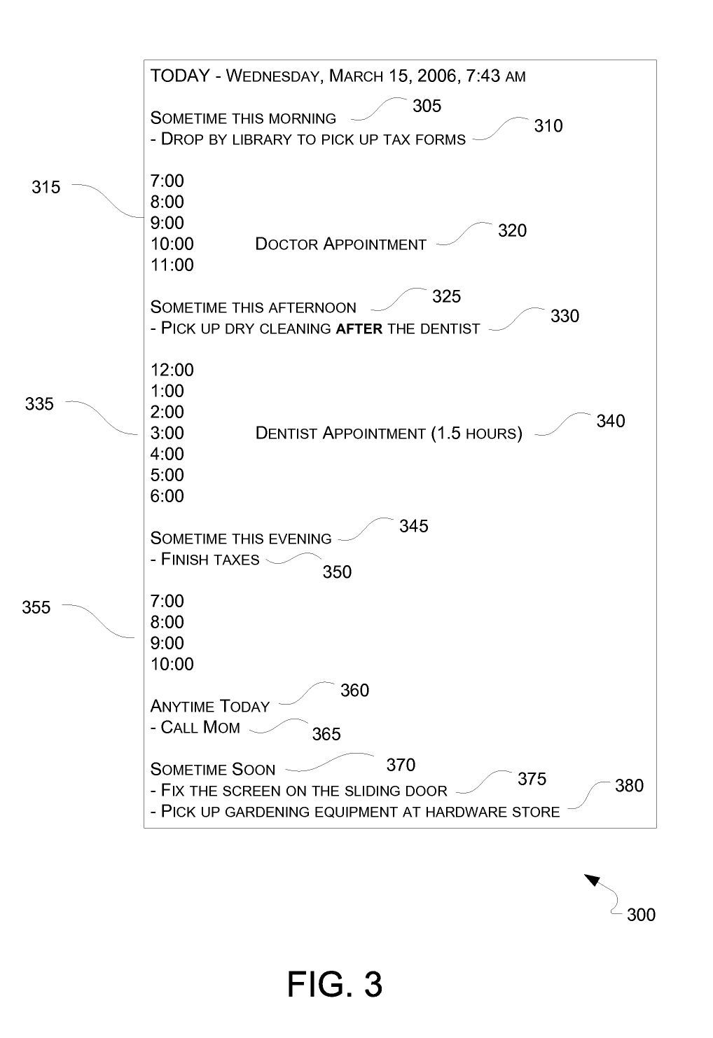

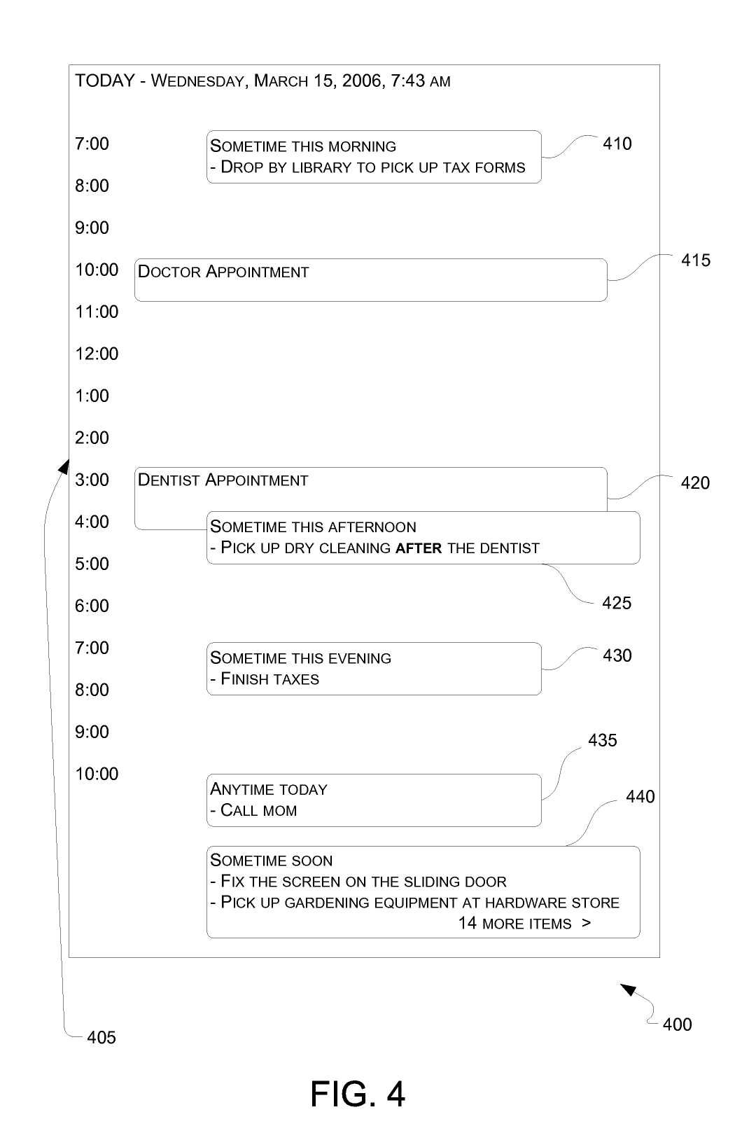

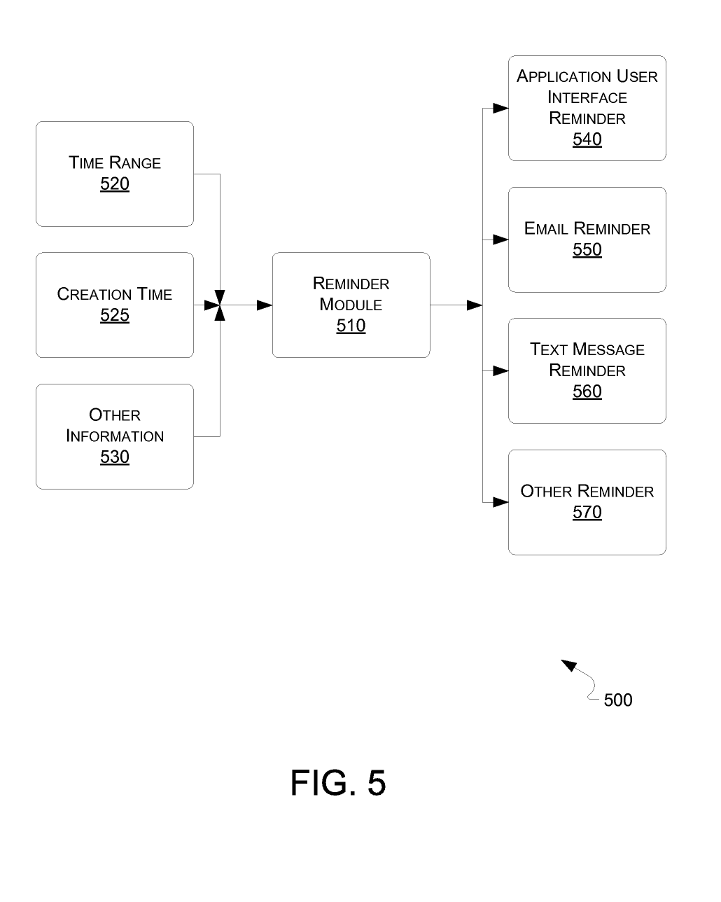

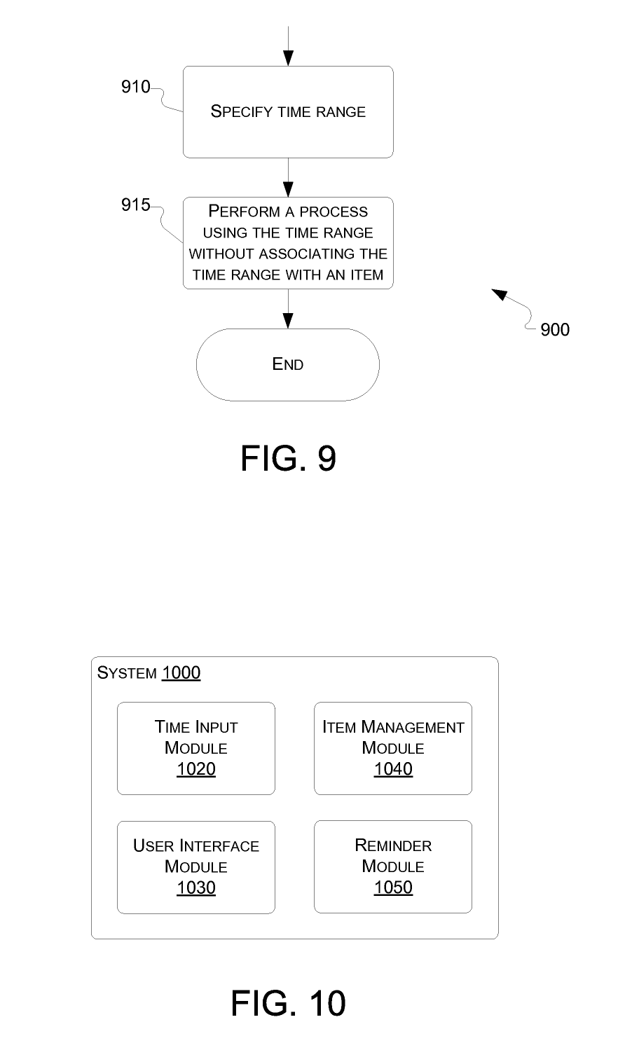

Turning now to FIG. 1, illustrated therein is an exemplary generalized operational flow 100 including various operations that may be performed when entering, associating, and using time ranges with tasks. The following description of FIG. 1 is made with respect to additional figures, including FIG. 2, FIG. 3, FIG. 4, FIG. 5, and FIG. 9. However, it should be understood that the operational flow described with respect to FIG. 1 is not intended to be limited to being used with the elements described with respect to these other figures. In addition, while the exemplary operational flow of FIG. 1 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

People are accustomed to thinking of some tasks, or things that they need to do, in terms of chunks of time instead of with respect to a single time or date. For example, a person might know that they want to “stop by the library to pick up tax forms this morning,” where the chunk of time in which to do the task is defined as “this morning.” As just a few of many possible additional examples, someone might know that they want to “call Mom before her birthday,” “landscape the front yard in the spring,” “pick up the dry cleaning when I drive by the dry cleaners,” and so on. In these examples, the chunks of time are “before her birthday,” “in the spring,” and “when I drive by the dry cleaners.”

Traditional personal information management applications and services typically provide task management functionality, but may not enable a user to define or manage tasks using chunks of time. Instead, a user might have the ability to associate a single due date or time with a task. A user might also have the ability to specify a specific time at which the personal information management application will remind the user of the task.

In one of many embodiments of the techniques and technologies described herein, a user may have the ability to specify a range of time during which a particular task should be performed. Such a range of time may be entered in a variety of ways. The time range associated with a task may then be used, also in a variety of ways, to provide functionality related to the task to the user.

In an implementation of operation 110, a task is created. In the context of this operation, the task may be any construct that represents something that needs to be done. For example, a person might have a “stop by library to pick up tax forms” task, a “call Mom” task, and so on. In some embodiments, the task might ultimately be accessed through some type of application, including a personal information management application. The task may include various pieces of information, some or all of which may be entered or added when the task is created, or may be entered or added at other times, including as part of subsequent operations in this operational flow. This information might include a description that in some cases may contain text that describes the action associated with the task—the description might hold the text “call Mom,” for example. It should be noted that, after this operation has been executed, in some implementations the task may have not yet have an associated time range, may not yet be accessible in a user interface, and may not be persisted to any kind of store, among other things. Furthermore, the created task may itself not have a description, or title, or any other kind of identifying information. In some implementations, this information may be added during this operation, while in other implementations this information may be added at some other point, either described in this operational flow or outside of this operational flow, or may not be added at all. In other implementations, any of the preceding actions may be performed as part of this operation.

In one implementation of operation 115, a user or some other entity may identify an item in some application, such as a personal information management application, and associate the identified item with the task created in operation 110. As used herein, the term “item” may refer to any construct with which a time range may be associated. Items may include tasks, appointments, entries on a calendar, and so on.

Based on the nature of the identified item, elements of the task may then be populated or entered, in some cases automatically, using information about the identified item. As one example, suppose a user's personal information management application manages various information about people (perhaps referred to as contacts) including, for example, a person's name, address, birthday, and so on. In this operation, the user might identify a person in such an application, perhaps by clicking, double-clicking, right-clicking and selecting an item from a menu, or through any other means by which the person might be identified. The task's description field might then be automatically populated with the text “Call <person name>”. In some implementations, the task might be linked through some means to the identified item—perhaps through a unique identifier associated with the identified item. In some other implementations, there may be no explicit link, except for perhaps information in text that may be automatically entered. In some implementations, the creation of a task, as explained previously with respect to operation 110, might happen when the user identifies an item—for example, a user might identify a person and only then may a task be created.

In an exemplary implementation of operation 120, a time range may be specified and associated with the task. In this context, the time range may specify a range of time during which the task is relevant somehow. In some embodiments, the time range may be the period of time during which the task should be accomplished. As just one example, given a goal to “landscape the front yard in the spring,” the time range may be from midnight of April 1 of this year to 11:59 pm of June 30 of this year. This time range might be such if the task is created sometime this year, before spring starts, and also perhaps if the task is created, say, sometime during the first two months of spring. If this task is created in the fall of this year, the resulting time range might be April 1-June 30 of next year, and so on. A wide variety of inputs and other data may be used when specifying a time range, including explicitly provided dates or times, periods of times, events to which a date range might relate, and so on. This wide variety of inputs may then be used in various ways to generate a time range. Some of these inputs and means for generating time ranges are discussed in more detail below, with respect to FIG. 2.

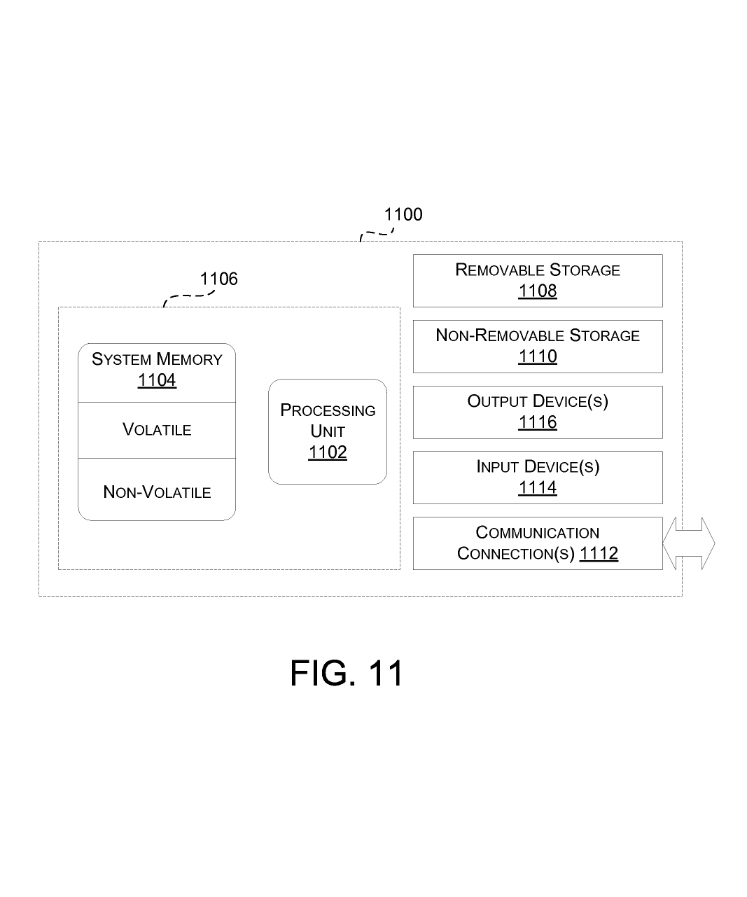

Regardless of the means by which the time range is specified, in operation 125, the task and the associated time range may be stored in some fashion. In some implementations this might involve persisting the task and time range to some type of persistent store, including disk or network-based stores like those discussed below with respect to FIG. 11. In the same or other implementations, the task and time range may be stored only transiently, for example in memory. The task and time range may be stored in a variety of fashions, as directed or used by an existing application, like a personal information management application, or in other fashions or through other means.

Regardless of the store, the time range itself may be stored in a variety of ways, as long as a range of time between two times or dates may be represented. In some implementations, a time range may be stored as a starting date or time and an ending date or time. In other implementations, a time range may be stored using a single time and an offset from that time represented in some fashion, including as any unit of time, including minutes, hours, days, quarters (that is, one of the four three month periods in a year), years, and so on. In other implementations, a time range may be stored differently.

It is important to note that, in the context of this application, the terms “date,” “time,” and “date/time” may refer to the same concept, which is a point in time. That is, a date may refer to a single day—like Jun. 24, 2006—but might also refer to a particular point in time during a day—like 3:45 pm on Aug. 26, 2006. A time or date/time value may refer to the same points in time, including Jun. 24, 2006 and 3:45 pm on Aug. 26, 2006.

Continuing, in an implementation of operation 130, any one of a variety of actions may be performed that uses the task and its associated time range, including actions that provide functionality that may be more difficult, or not possible, to provide when there is only a single a date or time associated with a task. This functionality may include displaying a user interface with task information and raising reminders that take into account the time range associated with the task.

Just one example of functionality enabled by the use of time ranges might be a user interface that displays tasks in close association with other items, including calendar items, such as appointments, instead of displaying tasks in their own list or view. For example, tasks that have a time range of “this morning” might be displayed in a calendar view with calendar items or appointments that have times during the morning, instead of being displayed in a completely separate task view, or in a part of the user interface dedicated solely to tasks. Some examples of user interfaces that display tasks using time range information are discussed below in more detail with respect to FIG. 3 and FIG. 4.

Another example of functionality enabled by the use of time ranges with tasks is enhanced reminders. In this context, an enhanced reminder may be associated with some action that serves to remind a user of a task or some other item, perhaps like an appointment, and that uses a time range as at least one part of the input when determining the nature of the reminder. For example, an exemplary reminder module may use a time range to determine when to remind a user of a task. In a simple implementation, the reminder module might raise a reminder at some period of time before the ending time in a time range. In more advanced implementations, a reminder module might raise a variety of reminders. For example, it might raise different types of reminders at different points in a time range—perhaps it first reminds a user of a task by displaying something in the user interface of the user's personal information management application. Then, as the end of the time range associated with the task approaches, perhaps the reminder module sends the user an email, and perhaps just before the time range is to end the reminder module sends a text message to the user's mobile telephone. How reminders might be generated and raised and some examples of the types of reminders that might be raised are discussed in more detail below, with respect to FIG. 5.

Other uses of time ranges with tasks and other items may be contemplated and still be encompassed by the invention as described herein.

It is important to note generally that not all of the steps in the exemplary operational flow described with respect to FIG. 1 may be necessary or implemented in all embodiments. In some embodiments, only some of the operations described with respect to FIG. 1 may be implemented. As one example, the item identification and association operation 115 may not be implemented or used in at least some implementations perhaps because, for example, the task is not created with respect to some other item, or the task is not intrinsically associated with a particular item. As another example, the store task and time range operation 125 may not be implemented or used in a case where the task is not stored.

Turning now to FIG. 2, shown therein is an exemplary block diagram that demonstrates some of the inputs that might be used when creating or specifying a time range. After such a time range is specified, it may be associated with a task—perhaps in a process similar to that described previously with respect to FIG. 1—or used in some other fashion, including, as just one example, as input to some other process, including as input to a query processor, as described below with respect to FIG. 9. This description of FIG. 2 is made with respect to FIG. 1 and FIG. 9. However, it should be understood that the elements described with respect to FIG. 2 are not intended to be limited to being used with the elements described with respect to these other figures. In addition, while the exemplary diagram in FIG. 2 indicates particular types of inputs, in some implementations not all of these inputs may be used, and in some implementations additional inputs may be used.

Included in the diagram of FIG. 2 are a time range 210, as well as different inputs that might be used when specifying the time range 210, including a text date or time period 235, other information 240, a date or time relative to some event 245, event information 250, and explicit dates or times 255. Any or all of these inputs, as well as additional inputs, may be used to determine the time range 210.

One input that may be used to specify a time range 210 is a text date or time period 235. In contrast to an explicit date or time 255, described below, a text date or time period 235 in this sense may often be specified using a time period that doesn't incorporate an explicit date or time—that is, using a time period that doesn't explicitly say, for example, “October 6,” “5:00 pm,” and so on. Instead, the text date or time period 235 may be specified in terms of periods of time, and in some cases also specified relative to particular dates or times. These periods of time include, but are not limited to, “this morning,” “this afternoon,” “this evening,” “today,” “tomorrow,” “tomorrow morning,” “tomorrow afternoon,” “tomorrow evening,” “next Monday” (and “next Tuesday,” and so on), “this weekend,” “next weekend,” “this week,” “next week,” “this month,” “next month,” “this quarter” (where a quarter is one of the four three month periods in a year), “next quarter,” “Q1” or “quarter 1,” “Q2,” “Q3,” “Q4,” “this fall,” “next fall,” “this winter,” “next winter,” “this spring,” “next spring,” “this summer,” “next summer,” and so on.

When a text date or time period 235 is specified, the corresponding time range 210 may be determined using the current time and date when the text date or time period is entered, or some other point in time. This point or date in time, including the current time and date, is one example of other information 240 that might be used to determine the time range 210. For example, if today's date is Oct. 28, 2006, a text date or time period of “tomorrow” might resolve to “Oct. 29, 2006” or “Oct. 29, 2006 12:00 am (midnight) to 11:59 pm.” On the same day, a text date or time period of “today” might resolve to “Oct. 28, 2006.” If the current time is 2:30 pm, the period “today” might resolve to time ranges like “2:30 pm to 11:59 pm,” or “October 28, 2:30 pm to 11:59 pm,” or “12:00 am (midnight) to 11:59 pm,” or “October 28, 12:00 am (midnight) to 11:59 pm.”

A particular point or date in time, like the current time and date, may also be used with additional logic to determine to which date or time period a particular input refers. For example, a text date or time period of “spring,” might in some cases refer to the time range from “April 1 of this year to June 30 of this year.” This time range might result when, for example, the current time when the time range is specified is sometime during the immediately preceding winter, or perhaps during the first one or two months of the spring. In contrast, if a text date or time period of “spring” is provided, for example, during the summer or fall of a particular year, the term “spring” might resolve to “April 1 of next year to June 30 of next year.”

Another example of a piece of other information 240 that might be used to determine a time range 210 from a text date or time period might be the periods of time that a particular user considers to refer to certain time periods, which may not be the same for all users. For example, a user might consider their “morning” to be from when they wake up to when they have lunch, which might actually resolve to, say, “5 am to 11:30 am.” As another example, a person that wakes up late might consider their morning to run from “11:00 am to 2:00 pm.”

Another piece of input that might be used to determine a time range 210 could be a date or time relative to some event or events 245. Information about this event or these events might be represented by the event information 250. In some cases with some implementations, the time range 210 may then run from the current time or date (or some other time or date) to some period of time before the particular event, including to a period of time just before the particular event. For example, a time range might be specified as “before Mom's birthday.” If this time range is created on Nov. 21, 2006 and “Mom's” birthday is on June 3, in this specific example, the resulting time range might run from “Nov. 21, 2006 to Jun. 2, 2007.” In some implementations, the birth date might be stored and used to automatically generate a new time range in each subsequent year—such time ranges might run from, for example, “June 3 of this year to June 2 of next year.”

A wide variety of events may be used to specify time ranges. These events include, but are not limited to, “before <some appointment/event on a calendar, or some other user-defined event>,” “before lunch,” “before dinner,” “before work,” “after work,” “before school,” “after school,” “when I get home,” “before I leave,” “when I'm near <some place or location>,” “next time I meet with <someone>,” “when <some particular task> is completed,” “when I get an email from <someone>,” “when I get a text message from <someone>,” “before the school year begins,” “before spring break,” “before winter break,” “before <some holiday>,” “before <someone's birthday>,” “before <someone's anniversary>,” “before my <some year> birthday,” “before the end of the year,” “when <some particular task> is to be done,” “when I attend <some appointment/event>,” and so on. Depending on the event, particular event information 250 may be necessary to generate the time range, including a particular appointment, a particular person, the dates of spring break or winter break (or some other period of time, like when school or work starts and ends), and so on.

Another way to specify a time range 210 may be to provide explicit dates or times 255. That is, one might specify a time range from “Mar. 9, 2006 to Apr. 23, 2006” by explicitly entering a start date of “Mar. 9, 2006” and an end date of “Apr. 23, 2006.”

In some implementations, more than one of the types of input may be used together to specify a time range 210. For example, in some embodiments it might be possible to use one or more explicitly specified dates or times with one or more of the other types of input illustrated in FIG. 2. For example, one might specify a time range by entering an explicit date or time 255—perhaps as a starting time—and also entering a text date or time period 235 that in this example is used as part of the input to determine the ending time.

Turning now to FIG. 3, shown therein is one example of a user interface that may be displayed when using tasks that have associated time ranges. This description of FIG. 3 is made with respect to FIG. 2. However, it should be understood that the elements described with respect to FIG. 3 are not intended to be limited to being used with the elements described with respect to FIG. 2. Furthermore, the user interface is exemplary and may be implemented in a variety of ways, using a variety of technologies, with a variety of differences from the exemplary user interface, and so on, without departing from the elements of the user interface as described herein.

The exemplary user interface 300 shows one manner in which items with time ranges, including tasks, may be displayed in the same context or user interface as other information. In this example, which might be part of a personal information management application or some other application, the user interface uses the time ranges on particular tasks so that the tasks may be displayed near appointments or calendar items with times that are similar in some way to the time ranges on the tasks. In doing so, the user interface interleaves the tasks with other calendar items—like appointments or events—that are commonly displayed in a user interface that contains a timeline or other view of a particular range of time. The exemplary user interface includes task display portions 305, 310, 325, 330, 345, 350, 360, 365, 370, 375, and 380 that display information about the time range associated with tasks and the tasks themselves, as well as appointment display portions 315, 335, and 355 that display appointments, and the appointment 320 and the appointment 340.

For example, the task “drop by library to pick up tax forms” 310 might have a time range like “Mar. 15, 2006 9:00 am to Mar. 15, 2006 11:59 am.” Time ranges, for this task as well as other items in the user interface 300, may have been specified using a variety of means, including, in some implementations, those described previously with respect to FIG. 2. For example, in one implementation, sometime during the previous day a user might have created this task and specified that it should be done “tomorrow morning,” which then resolved to the time range of “Mar. 15, 2006 9:00 am to Mar. 15, 2006 11:59 am.” In another instance, a user might have simply specified a time range explicitly, or used any means available to specify a time range.

This exemplary user interface includes a portion labeled “sometime this morning” 305 which may display tasks that have time ranges in the morning. This may include tasks that have time ranges that occupy all of or a substantial portion of the morning, such as the previously mentioned task 305, as well tasks with time ranges of shorter durations—like “10:00 am to 10:30 am”—and tasks with time ranges that include some part of the morning, but also include other parts of the day, for example.

The portion of the user interface 300 labeled “sometime this afternoon” 325 includes a “pick up dry cleaning after the dentist” task 330. This task might have been specified in a variety of ways, as before, and might have a time range like “4:30 to 5:30,” given that the “dentist appointment” 340 is set to run from 3:00 to 4:30. The “sometime this evening” 345 portion of the user interface includes a “finish taxes” task 350 that might have a time range like “6:00 to 11:00.”

The portion of the user interface 300 labeled “anytime today” 360 may hold tasks with ranges that, in some implementations, span all of or a large part of the day. In this instance of this exemplary user interface, tasks with time ranges of “March 15 at 12:00 am (midnight) to March 15 at 11:59 ” or “March 15 at 6:00 am to March 15 at 6:00 ,” and so on, might be displayed in a portion of the user interface like the “anytime today” portion 360. In this exemplary user interface, this includes a “call Mom” task 365.

Finally, the portion of the user interface 300 labeled “sometime soon” 370 might include all of or some selected set of tasks that have time ranges that include today's date, or that include one or more dates that will occur in the, possibly near, future. As such, a portion of the user interface like this might have, as one of its purposes, the goal of reminding users of relevant tasks that may not fall into a particular period of a day, including today. For example, the “fix the screen on the sliding door” task 375 might have a time range that includes this entire week—for example, it might run from a previous date to a date in the future, say, from “March 13 at 12:00 am (midnight) to March 19 at 11:59.” The exemplary “pick up gardening equilent at hardware store” task 380 in contrast, might be specified for only the upcoming weekend, with a time range like “March 18 at 8:00 am to March 19 at 6:00.”

In the same or other implementations, the user interface 300 may display the tasks or items associated with other time ranges, may use different divisions than illustrated in the user interface 300—for example it might show all of the tasks associated with both the morning and afternoon in a single portion of the user interface, may display other types of information in addition to appointments and tasks, and may further modify the user interface in other ways while not departing from the elements of the user interface described herein. Further, it should be noted that the definitions of what comprises the different parts of the user interface, including the exemplary morning, afternoon, and evening portions shown in this example, may in some implementations be fixed and in other implementations may be flexible. For example, such definitions may at least in part be specified by the user.

Turning now to FIG. 4, shown therein is another example of a user interface that may be displayed when using tasks that have associated time ranges. This description of FIG. 4 is made with respect to FIG. 3. However, it should be understood that the elements described with respect to FIG. 4 are not intended to be limited to being used with the elements described with respect to FIG. 3. Furthermore, the user interface is exemplary and may be implemented in a variety of ways, using a variety of technologies, with a variety of differences from the exemplary user interface, and so on, without departing from the elements of the user interface as described herein.

The user interface 400 displays the same information as was displayed and discussed previously with respect to FIG. 3. For example, the user interface displays the same appointments and tasks. However, in contrast to the user interface of FIG. 3, the user interface 400 uses a single contiguous list of times 405. Such a list might be common, for example, in the calendar view of a personal information management application. The user interface 400 also displays the tasks overlaid on top of and/or offset from the other items, like appointments, that are also shown in the user interface. The exemplary user interface includes a single contiguous list of times 405 that in this example runs from 7:00 am to 10:00, task display portions 410, 425, 430, 435, and 440 that display information about the time range associated with tasks and the tasks themselves, and appointment display portions 415 and 420.

The appointment 415 and appointment 420 are displayed as blocks that occupy the amount of time specified for the appointment. For example, the “doctor appointment” 415 is shown as being from 10:00 am to 11:00 am while the “dentist appointment” 420 is shown as being from 3:00 to 4:30.

In contrast, the task display portions are not necessarily displayed as occupying the time range associated with the task or tasks identified for a particular task display portion. Instead, the time range associated with one or more tasks may be used to identify in which task display portion the task or tasks should be displayed. The task display portion then itself may be displayed within the same user interface as the calendar items and appointments, perhaps overlaid upon calendar items, offset from calendar items, or otherwise distinguished in some fashion from the calendar items and appointments. In other implementations, the tasks may be displayed in the same fashion as calendar items or appointments and may not be distinguished one from the other.

Tasks that have time ranges that place them into particular times may be displayed in task display portions that are located near the times for that particular period. For example, using the same tasks and time ranges explained previously with respect to FIG. 3, the “drop by the library to pick up tax forms” task is displayed in the “sometime this morning” task display portion 410. As this task has a time range with a value perhaps like “Mar. 15, 2006 at 9:00 am to Mar. 15, 2006 at 11:59 am,” it may be located in a task display portion with a title like “sometime this morning,” where the task display portion is located in the user interface near times associated with the morning. Note that the task or the task display portion is not necessarily located exactly at, for example, the time associated with the start of the time range of the task. In this specific example, the “drop by the library to pick up tax forms” task has a starting time of 9:00 am, but is actually displayed in a task display portion 410 that in this exemplary user interface is near the time of 7:00 am. The location of the exemplary task display portion 410 illustrates graphically that the task is associated with times in the morning, and as long as it accomplishes the goal of communicating visually one or more times with which the task is associated, its exact location in the user interface may vary.

When a task is specified to exist in relation to a calendar item or appointment, the task display portion that displays that task may be located in a position that indicates the relationship to the particular calendar item or appointment. In this exemplary user interface 400, the “pick up dry cleaning after the dentist task” is displayed in the task display portion 425, which is located immediately below the “dentist appointment” 420, and which thereby graphically indicates that the task is associated with a time range that is after the particular calendar item.

In a case where some tasks have time ranges that relate to items on the calendar while other tasks have time ranges that are independent of calendar items or appointments, the user interface may display multiple task display portions—for example, it might have multiple “sometime this afternoon” task display portions, may group all of the relevant tasks into the same task display portion, or use some other mechanism to display tasks.

Similar to the “sometime this morning” task display portion 410 described previously, the “sometime this evening” task display portion 430 is displayed in a part of the user interface 400 associated with the evening, and displays the “finish taxes” task that has a time range associated with the evening.

The “anytime today” task display portion 435 and “sometime soon” task display portion 440 are illustrated in the user interface 400 in positions that do not indicate an association with a specific period of time in the day. These task display portions might be located at the top of the user interface, further to the side of the times, or in any other position, especially those positions that do not imply a perhaps strong correlation with a particular period of time in the day.

The “sometime soon” task display portion 440 illustrates one additional type of displayed information with the text “14 more items.” Any task display portion—including those described previously with respect to user interface 300 in FIG. 3—may contain more tasks than can be displayed in a particular instance of the user interface. In these cases, in some implementations a variety of mechanisms may be used to indicate that there are additional tasks that are not displayed. These mechanisms include a text string that displays the number of items that are not displayed. In some implementations, the text string or other user interface element may be a hyperlink, button, or may be active in some way so that clicking, selecting, or specifying the user interface element leads to the display of some or all of the previously not displayed tasks or items.

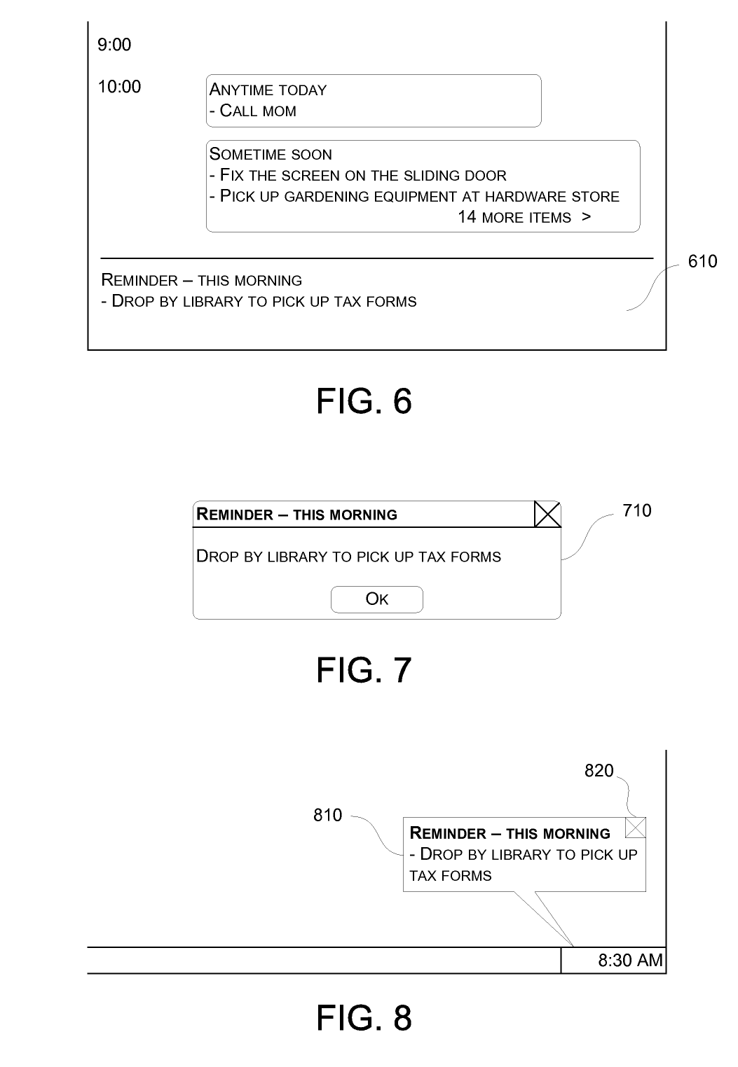

Turning now to FIG. 5, shown therein is a diagram that demonstrates the operation of an exemplary reminder module 510 that determines and raises reminders using time ranges associated with items, including in some implementations, tasks and/or appointments on a calendar. Using input information like a time range, the reminder module may raise one or more reminders, perhaps of different types and at different times, for a single item. The description of FIG. 5 is made with respect to figures such as FIG. 6, FIG. 7, and FIG. 8. However, it should be understood that the elements described with respect to FIG. 5 are not intended to be limited to being used with the elements described with respect to other figures. In addition, while the exemplary diagram in FIG. 5 indicates particular blocks, such as inputs and outputs, in some implementations not all of these blocks may be used, and in some implementations additional blocks may be used.

The exemplary reminder module 510, in the exemplary system 500, may accept a variety of pieces of input data to use when determining reminders to raise. These pieces of input may include a time range 520, a creation time 525, and other information 530. Given this input data, the reminder module 510 may determine if any reminders are needed, and if so, may raise those reminders at one or more appropriate times. The mechanism by which the reminder is delivered to a user may vary, and may include an application user interface reminder 540, an email reminder 550, a text message reminder 560, or other reminders 570. As used herein, the phrase “raise a reminder” means to fire, surface, or otherwise deliver a reminder to a user. The means by which a reminder is raised might depend on, among other things, the mechanism by which the reminder is delivered to a user. For example, an application user interface reminder 540 might be raised, at least in part, by displaying information about the reminder in a user interface, an email reminder 550 might be raised, at least in part, by sending an email to a user, and a text message reminder 560 might be raised, again at least in part, by sending a text message to a user's mobile phone, and so on.

The time range 520 may be used by the reminder module in a variety of ways, including by itself—that is, independently of other types of input information—and in conjunction with the creation time 525 and/or the other information 530. In the context of the reminder module, the time range used may be a time range of any item that has an associated time range. For example, the time range associated with a task might be used by the reminder module to determine if any reminders are needed and when and how any reminders should be raised. A time range associated with any other kind of item that may have an associated time range—perhaps like a calendar item or appointment—may also be used in a similar way by the reminder module.

One of the ways in which the reminder module 510 might use the time range 520 may be to determine when to raise reminders and the mechanisms with which reminders are delivered to a user. Items with a single associated date, like a due date, might only enable a reminder module to raise a single reminder at some period before the due date. In contrast, the use of a time range might enable the reminder module to perform additional operations, such as raising multiple reminders at different times, and delivering the reminders using different mechanisms.

By raising reminders at different times and delivering the reminders using different mechanisms, users might, for example, initially be unobtrusively reminded about a task that isn't due in the immediate future—that is, a task whose time range doesn't expire for some time. Then, as the end of the time range comes closer, a user might be reminded using some mechanism that is more obtrusive, conspicuous, or harder to ignore. As just one example, suppose a time range of “May 14 at 9:00 am to May 14 at 5:00” that is associated with a task. Because this time range may be considered relatively short—it occupies just a single day and not a week, month, or other longer period of time—the reminder module 510 might raise a reminder unobtrusively the day before the start of the time range. This reminder could be raised in a wide variety of ways, including using one or more instances of application user interface reminders 540, as discussed below in more detail. Then, on the morning of May 14, the reminder module might raise a reminder in a somewhat more obtrusive or noticeable manner, perhaps again using some form of application user interface reminder 540. When the user completes the task at some point during the day, the reminder module might stop raising reminders. If the user does not complete the task, and as the end of the time range draws closer, the reminder module might raise additional reminders for the task, perhaps using more conspicuous means. For example, if the user has not completed the task by 2:00, the reminder module might raise a text message reminder 560 by sending a text message to the user's mobile phone.

It should be noted that the previous example demonstrates just one exemplary sequence of reminders for just one exemplary time range. Depending on various factors, including the length of the time range and the types of delivery mechanisms available, as well as other inputs and user preferences, the specific sequence of reminders raised, when reminders are raised, the means by which reminders are delivered, and so on, may vary widely. As just one example, reminders for a task that has a time range of an entire quarter—perhaps it runs from “January 1 at 12:00 am (midnight) to March 31 at 11:59”—might not be raised before the time range starts. Instead, unobtrusive reminders might be raised at the beginning of the time range, with more obtrusive or noticeable reminders being raised at periods closer to the end of the time range.

Another piece of input data that might be used by the reminder module 510 is the creation time 525 of the item for which reminders are being determined. The creation time 525 might be used in conjunction with other pieces of input data to determine the reminders to raise. For example, in some embodiments, an item that has been created some time ago might warrant more reminders, or more noticeable reminders, at the beginning of a time range then an item that has just been created. A mechanism like this might be useful in that it may provide reminders earlier for items that a user might have forgotten because they were entered long ago, while not bothering users with reminders for items that they have just created and so perhaps have not forgotten.

In addition to the time range 520 and the creation time 525, a variety of other pieces of input data may be used by the reminder module 510. This other information is represented in the system 500 by the other information 530, and includes any other information used by the reminder module when determining the reminders to raise, when any such reminders should be raised, the mechanism by which the reminders should be delivered, and so on. One exemplary piece of other information 530 might be a priority associated with the item for which reminders are being determined. For example, a task marked as “high priority” or “must do” might warrant a more aggressive set of reminders, including more reminders and reminders delivered using more conspicuous means that are more likely to be noticed by a user, such as text messages to a mobile phone.

As previously discussed, the reminder module 510 may deliver reminders using a variety of mechanisms.

One such mechanism may be an application user interface reminder 540. Such a reminder may be any reminder displayed in or associated with the user interface of an application or a computing device. The application user interface reminder might be displayed in one or more parts of the user interface of the application itself, or of another application, or might be displayed using an associated type of user interface, like a dialog box or pop-up or other type of notification user interface. Some examples of application user interface reminders are discussed below in more detail with respect to FIG. 6, FIG. 7, and FIG. 8.

The degree to which an application user interface reminder 540 is noticeable by the user might be used by the reminder module 510 as part of the decision about when to use that particular type of application user interface reminder. For example, a dialog box may display in the foreground of whatever application or applications a user is using, and might require an explicit action—like clicking an “OK” button—to dismiss. As such, a dialog box may be considered relatively obtrusive and noticeable, and raising a reminder using a dialog box might only be done when, for example, the item has a high priority and the time range associated with the item is nearly complete. In contrast, displaying a reminder within an unobtrusive portion of an application user interface—perhaps in a pane at the bottom of an application user interface—might be less obtrusive and so used when, for example, there is some time before the time range of an item will be complete, or an item is due. In other cases the portion of the application user interface may be prominent and reminders displayed using this portion of the application user interface might be considered to be even more noticeable than other mechanisms, including those like a dialog box.

As mentioned previously, two other mechanisms by which the reminder module 510 might deliver reminders are email reminders 550 and text message reminders 560. These reminders may be delivered through various email and text message applications, services, and the like, including those already used by an application or computing device associated with the reminder module, or other applications, services, and so on.

Finally, reminders might be delivered using a variety of other mechanisms, as represented by the other reminders 570. Any other means by which a user might be reminded of an item may be considered a part of the other reminders 570.

Turning now to FIG. 6, shown therein is an example of an application user interface reminder 540 where the reminder is shown in the user interface of an application. In this example, the application user interface reminder is shown in a reminder display pane 610 at the bottom of a part of an application like that described previously with respect to FIG. 4, although of course this type of application user interface reminder might be used in any view or portion of an application, or in fact in any application. In this example, the reminder display pane 610 might be a single place where a user should look for upcoming tasks. Depending on the location of a user interface element like the reminder display pane and other user interface design choices, such as the font(s) used in the reminder display pane, and so on, the reminders shown in such a reminder display pane may be associated with varying degrees of importance. Also, while the reminder display portion shows a single reminder in this figure, it may of course hold any number of reminders, as dictated by the design of the user interface and the reminder module.

Turning now to FIG. 7, shown therein is an example of an application user interface reminder 540 implemented as a dialog box. Such a dialog box 710 might be associated with but shown outside of an application user interface, or may not appear to be or actually be associated with an application, so long as it provides information about one or more reminders. As discussed previously, the use of a dialog box 710 might be common for reminders that are meant to be more conspicuous or noticeable because dialog boxes often, but not always, require some type of affirmative user action before they are dismissed or no longer displayed. (However, a dialog box may be used at any time, depending on the implementation of the reminder module.) In some implementations, a dialog box may be used to display multiple reminders at a single time, while in other implementations or the same implementations at other times, a dialog box may only show information about one reminder at a time. Dialog boxes may of course be implemented in a variety of ways and may appear using a variety of visual styles, and so on. No particular arrangement of user interface elements in the dialog box—such as a particular button or arrangement of text—is required.

Turning now to FIG. 8, shown therein is an example of one type of non-dialog box application user interface reminder 540 displayed outside of the user interface of an application. In this example, the reminder is a notification 810 displayed from a portion of the user interface that is in this case outside the application with which the notification is associated. In some implementations, such a notification may automatically disappear after a preset amount of time. A user may also have the ability to dismiss the notification by, for example, clicking a part of the user interface associated with dismissing the notification, such as a dismiss button, perhaps like that illustrated with dismiss button 820. In some implementations, an application user interface reminder 540 like notification 810 might be used for reminders that do not require the same level of user involvement as reminders associated with, for example, dialog boxes, as the user may not have to explicitly dismiss the notification 810. In other implementations, depending on how the notification is displayed, dismissed, and so on, the notification may be used for reminders that require other levels of user involvement.

Turning now to FIG. 9, illustrated therein is an exemplary generalized operational flow 900 including various operations that may be performed using a time range without associating the time range with an item like a task or appointment. The following description of FIG. 9 is made with respect to FIG. 1 and FIG. 2. However, it should be understood that the operational flow described with respect to FIG. 9 is not intended to be limited to being used with the elements described with respect to these other figures. In addition, while the exemplary operational flow of FIG. 9 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In operation 910, a time range is specified. A wide variety of inputs and other data may be used when specifying a time range, including explicitly provided dates or times, periods of times, events to which a date range might relate, and so on. This wide variety of inputs may then be used in various ways to ultimately generate a time range. Some of the inputs and means for generating time ranges that might be used have been discussed in more detail previously, with respect to FIG. 2.

In operation 915, a process is performed that uses the time range entered in operation 910 as at least one input. The time range is not associated with an item, as it was, for example, in the operational flow 100 described previously with respect to FIG. 1. Instead, the time range is used as input to some process.

One example of such a process is a process that queries a data store for all items that have some specified relation to a time range. As one specific example, a user might want to retrieve all items, like appointments or tasks, that are in a time range specified by the time range input in operation 910. Using the ability to enter a time range in more flexible terms—such as using text date or time periods or dates or times relative to some other event, as was explained previously with respect to FIG. 2—may provide a more usable or intuitive interface than one that only supports the input of a time range by providing explicit dates and times.

Turning now to FIG. 10, shown therein is an exemplary system 1000 in which the entry, association, and use of time ranges may occur. Included in the system are a time input module 1020, a user interface module 1030, an item management module 1040, and a reminder module 1050. This description of FIG. 10 is made with respect to figures such as FIG. 1, FIG. 2, FIG. 5, FIG. 9, and FIG. 11. However, it should be understood that system described with respect to FIG. 10 is not intended to be limited to be used with the elements illustrated by other figures.

The system 1000 contains various modules and components, discussed below, that may perform a variety of operations related to the entry, association, and use of time ranges. The system 1000 might be a part of a computing device, like those described below with respect to FIG. 11.

The time input module 1020 may provide the ability to enter time ranges. The time ranges may then be used by the other modules in the system to carry out various operations. For example, entered time ranges may be used by the item management module 1040 as part of the process of, for example, associating time ranges with items like tasks or appointments. A wide variety of inputs and other data may be used when specifying a time range, including explicitly provided dates or times, periods of times, events to which a date range might relate, and so on. This wide variety of inputs may then be used in various ways to ultimately generate a time range. In some implementations, some of these inputs and means for generating time ranges may be like those discussed in more detail previously, with respect to FIG. 2.

The user interface module 1030 may display various user interface elements associated with the system 1000, depending on the purpose of the particular instance of the system. For example, perhaps where the system 1000 comprises a personal information management application, the user module 1030 may provide a user interface that enables users to view and manage items like appointments and tasks. It may also be associated with other operations, including the display of reminders such as those generated by a module like the reminder module 1050.

The item management module 1040 may manage at least some of the items used by the system 1000. In some embodiments, the item management module may create items and associate time ranges with such created items. It may use time ranges perhaps provided by a module like the time input module 1020. The item management module might also be responsible for operations such as those described previously with respect to FIG. 1 and that are already handled by other modules in the system. This may include identifying and associating items with tasks and storing items and time ranges. In the same or other implementations, the item management module may enable querying of the items it manages, perhaps, for example, using a time range obtained from the time input module 1020 as input, perhaps using a mechanism similar to that described previously with respect to FIG. 9.

The reminder module 1050 may enable the management, determination of, and raising of reminders, perhaps using information from other modules in the system, including the item management module 1040 (which may in turn have used time ranges entered using the time input module 1020). In some implementations the reminder module 1050 may be similar to or the same as the reminder module 510 described previously with respect to FIG. 5, while in other implementations it may be different. In some implementations, the reminder module 1050 may use the user interface module 1030 as part of the process of raising reminders to users.

It should be understood that while the exemplary system 1000 contains various modules, in one or more alternative implementations, a single module may perform more than one of the operations associated with the modules in the system 1000. Also, in one or more alternative implementations, the modules may perform additional operations not shown or discussed. In addition, not all of the modules may be implemented in all systems. As just one example, a system that does not raise reminders may not include a reminder module 1050. Furthermore, in one or more alternative implementations, the modules may reside on more than one device or computer system. In the same or other implementations, particular modules that provide functionality might be implemented on one or more remote computing devices, perhaps connected via some type of remote procedure call or other communication mechanism. When more than one device is involved, the communication between the devices may be accomplished using a variety of methods, including by using a wireless connection of some kind, by using a wired connection, or by any other communication mechanism with which computing devices may communicate.

### Example Computing Environment

Turning now to FIG. 11, this figure and the related discussion are intended to provide a brief, general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 1100 illustrated in FIG. 11.

Generally, program modules include routines, programs, objects, components, user interfaces, data structures, etc., that perform particular tasks, display particular information, or implement particular abstract data types. Operations performed by the program modules have been described previously with the aid of one or more block diagrams, user interface diagrams, and operational flowcharts.

Those skilled in the art can implement the description, block diagrams, user interfaces, and flowcharts in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

The computing device 1100 illustrated in FIG. 11, in its most basic configuration, includes at least one processing unit 1102 and memory 1104. Depending on the exact configuration and type of computing device, the memory 1104 may be volatile (such as RAM), non-volatile (such as ROM, flash memory, etc.), or some combination of the two. This most basic configuration is illustrated in FIG. 11 by dashed line 1106. Additionally, the computing device 1100 may also have additional features and functionality. For example, the computing device 1100 may also include additional storage (removable and/or non-removable) including, but not limited to, magnetic or optical disks or tape. Such additional storage is illustrated in FIG. 11 by the removable storage 1108 and the non-removable storage 1110.

The computing device 1100 may also contain one or more communications connection(s) 1112 that allow the computing device 1100 to communicate with other devices and services. For example, the computing device might have one or more connections to email or text message servers, services, or the like, that it may use to send email or text messages, perhaps in a manner similar to that explained previously with respect to, for example, FIG. 5. The computing device 1100 may also have one or more input device(s) 1114 such as keyboard, mouse, pen, voice input device, touch input device, image input device (like a camera or scanner), etc. One or more output device(s) 1116 such as a display, speakers, printer, etc. may also be included in the computing device 1100. For example, one or more of the output devices might be used to display user interfaces of the sort explained with respect to, without limitation, FIG. 3, FIG. 4, FIG. 6, FIG. 7, and FIG. 8.

Those skilled in the art will appreciate that the technologies described herein may be practiced with computing devices other than the computing device 1100 illustrated in FIG. 11. For example, and without limitation, the technologies described herein may likewise be practiced in hand-held devices including mobile telephones and PDAs, multiprocessor systems, microprocessor-based or programmable consumer electronics, network PCs, minicomputers, mainframe computers, and the like. Each of these computing devices may be described, at some level of detail, by the system of FIG. 11, or may be described differently.

The technologies described herein may also be implemented in distributed computing environments where operations are performed by remote processing devices that are linked through a communications network. In a distributed computing environment, program modules may be located in both local and remote devices.

While described herein as being implemented in software, it will further be appreciated that the technologies described herein may alternatively be implemented all or in part as hardware, firmware, or various combinations of software, hardware, and/or firmware.

Although some particular implementations of methods, systems, and user interfaces have been illustrated in the accompanying drawings and described in the foregoing text, it will be understood that the methods, systems, and user interfaces shown and described are not limited to the particular implementations described, but are capable of numerous rearrangements, modifications and substitutions without departing from the spirit set forth and defined by the following claims.

What is claimed is:

1. A computer-implemented method comprising:
specifying a time range;
associating the time range with a task; and
performing an action using the task based on the time range.

2. The method of claim 1 wherein performing the action further comprises displaying a user interface.

3. The method of claim 2 wherein displaying a user interface further comprises:
displaying a calendar item; and
displaying the task in the same portion of the user interface as the calendar item by using the time range.

4. The method of claim 3 wherein the time range is used so that the task is displayed interleaved with the calendar item.

5. The method of claim 3, further comprising:
displaying a contiguous list of times; and
wherein the time range is used so that the task is displayed offset from the calendar item.

6. The method of claim 1 wherein performing the action further comprises raising a reminder.

7. The method of claim 6 wherein raising the reminder further comprises at least one of the following:
displaying information about the reminder in a dialog box;
displaying information about the reminder in a user interface of an application or a system;
sending an email message with information about the reminder; and
sending a text message with information about the reminder.

8. The method of claim 6 wherein the reminder is raised before the beginning of the time range, when the time range's duration is equal to or less than one day.

9. The method of claim 6 wherein the reminder is raised at a time inside the time range, when the time range's duration is greater than one day.

10. The method of claim 1 further comprising:
identifying an item with which to associate the task; and
associating the task with the item.

11. The method of claim 1 further comprising:
storing the task and the time range.

12. The method of claim 1 wherein specifying the time range further comprises defining the time range using a text date or time period.

13. The method of claim 12 wherein the text date or time period further comprises one of the following time periods:
this morning; this afternoon; this evening; today; tomorrow; tomorrow morning; tomorrow afternoon; tomorrow evening; this weekend; next weekend; this week; next week; this month; next month; this quarter; next quarter; Q1; Q2; Q3; Q4; this season; this fall; next fall; this winter; next winter; this spring; next spring; this summer; and next summer.

14. The method of claim 1 wherein specifying the time range further comprises defining the time range relative to an event.

15. The method of claim 1 wherein specifying the time range further comprises explicitly identifying two times, and defining the time range as the range existing between the two times.

16. A computer-implemented method comprising:
specifying a time range using one of:
a text date or time period; and
a date or time relative to an event; and
performing a process using the time range without associating the time range with an item.

17. The method of claim 16 wherein performing the process further comprises querying a set of items that each have at least one associated date, and identifying a second set of items from the set of items where the at least one associated date for each of the second set of items is within the time range.

18. A user interface displayed in a computer system, comprising:
a calendar item displayed in the user interface;
a task displayed in the user interface; and
wherein the task has an associated time range and the task is displayed in the same portion of the user interface as the calendar item by using the time range.

19. The user interface of claim 18 wherein the time range is used so that the task is displayed interleaved with the calendar item.

20. The user interface of claim 18 wherein the user interface further comprises a contiguous list of times and the time range is used so that the task is displayed offset from the calendar item.
